(19) United States
(12) Patent Application Publication
(10) Pub. No.: US 2025/0070704 A1
(43) Pub. Date: Feb. 27, 2025

(54) CONTROL APPARATUS, IMAGE PICKUP APPARATUS, AND CONTROL METHOD

(71) Applicant: CANON KABUSHIKI KAISHA, Tokyo (JP)

(72) Inventor: HIROFUMI HONDA, Tokyo (JP)

(21) Appl. No.: 18/744,020

(22) Filed: Jun. 14, 2024

(30) Foreign Application Priority Data
Aug. 23, 2023 (JP) 2023-135900

(51) Int. Cl. H02P 23/14; G02B 7/02

(52) U.S. Cl. CPC H02P 23/14; G02B 7/02

(57) ABSTRACT

A control apparatus includes a memory storing instructions, and a processor configured to execute the instructions to generate target position information on a motor, acquire rotational position information on the motor, generate a drive signal of the motor according to a shift amount between the target position information and the rotational position information, and set an origin for coordinates of the rotational position information according to a difference between a center value of a fluctuation amount of the rotational position information and a fluctuation amount of the rotational position information.

### BACKGROUND

### Technical Field

One of the aspects of the embodiments relates to a control apparatus, image pickup apparatus, and control method for a stepping motor using an encoder.

### Description of Related Art

For the maximized rotation efficiency, higher speed, and power saving of a motor, a method has conventionally been proposed for controlling a lead angle of a drive waveform relative to a rotation phase of the motor obtained from a sensor. Japanese Laid-Open No. 2021-083196 discloses a method for controlling a lead angle of a drive waveform by inversely converting into a waveform signal a drive counter generated by adding to rotation position information on a motor a target lead angle determined based on a deviation between position information and a target position of control. Japanese Patent No. 6168841 discloses a configuration for calculating a second drive amount according to a ratio of a step phase in a case where the step phase of a predetermined phase area is included when microstep driving is performed with a first drive amount.

The rotation position information on the motor may fluctuate due to the cogging or the detection accuracy of the rotation phase of the motor. In this case, the configuration of Japanese Patent Laid-Open No. 2021-083196 causes a coordinate shift in the rotation position information on the motor, and cannot correctly set the lead angle. The configuration of U.S. Pat. No. 6,168,841 attempts to suppress variations in the rotation amount caused by cogging by adjusting the microstep drive amount based on the rotational position information on the motor, but cannot suppress the coordinate shift in the rotational position information.

### SUMMARY

A control apparatus according to one aspect of the disclosure includes a memory storing instructions, and a processor configured to execute the instructions to generate target position information on a motor, acquire rotational position information on the motor, generate a drive signal of the motor according to a shift amount between the target position information and the rotational position information, and set an origin for coordinates of the rotational position information according to a difference between a center value of a fluctuation amount of the rotational position information and a fluctuation amount of the rotational position information. An image pickup apparatus having the above control apparatus and a motor control method corresponding to the above control apparatus also constitute another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B explain a motor unit according to this embodiment.

FIG. 2 is a block diagram of the motor unit including an electric circuit for driving.

FIG. 3 illustrates processing by an encode processing unit.

FIG. 4 illustrates a relationship between a lead angle and a motor rotation speed.

FIG. 5 is a flowchart illustrating processing by a lead angle and power rate control unit.

FIG. 6 is a flowchart illustrating a target lead angle and power rate selecting processing.

FIG. 7 is a flowchart illustrating speed control processing.

FIG. 8 illustrates lead angle control processing.

FIG. 9 illustrates a relationship between variations in origin setting timing and phase variations of the origin.

FIGS. 10A to 10C illustrate a relationship between a position detecting counter and a target position counter.

FIG. 11 is a flowchart illustrating origin setting processing.

FIGS. 12A to 12C illustrate a relationship between the timing and count value in setting the origin.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

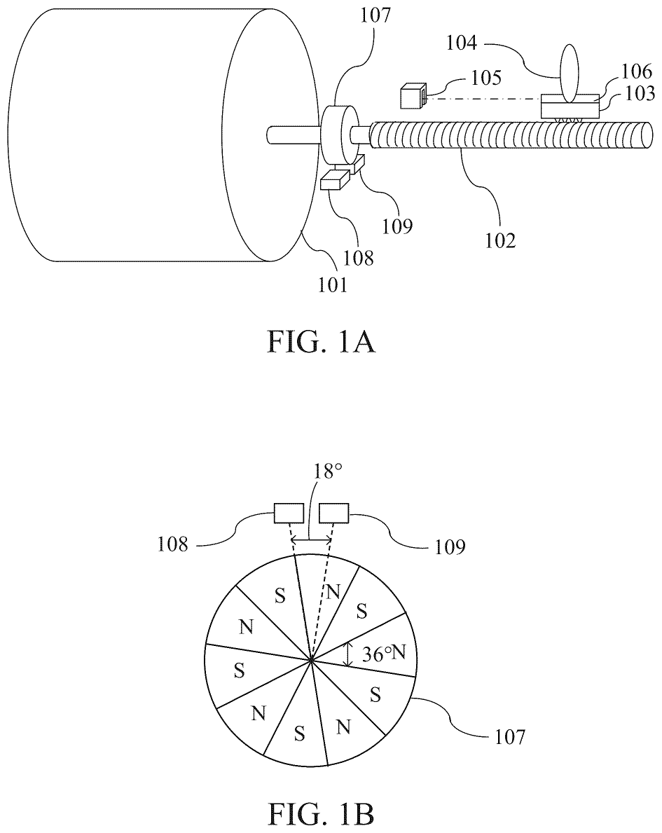

FIG. 1A illustrates a schematic configuration of a motor unit according to this embodiment. A rotating shaft 102 of a stepping motor (simply motor hereinafter) 101 is a lead screw and is engaged with a rack 103. A lens (movable member) 104 as a driven member is connected to the rack 103 and is movable in an axial direction according to the rotation of the rotating shaft 102. In this embodiment, the lens 104 is used as an example of a movable member, but this embodiment is not limited to this example.

A reference position for the lens 104 is determined by a photo-interrupter (PI) 105 disposed on an unillustrated fixed member and a light shielding plate 106 provided on the lens 104. The PI 105 includes a light emitter and a light receiver, and when the light shielding plate 106 enters between the light emitter and the light receiver as the lens 104 moves, a detection signal of the PI 105 switches from a high level to a low level. This switching position is set as the reference position. In this embodiment, the PI 105 and the light shielding plate 106 constitute a position detector.

A rotation-phase detecting magnet 107 is attached to the rotating shaft 102, and configured to detect the rotation phase (rotational position) of the motor 101 in combination with a pair of Hall sensors (Hall-Ch0) 108 and (Hall-Ch1) 109, which serve as detectors.

FIG. 1B explains the arrangement of the rotation-phase detecting magnet 107 and the Hall sensors 108 and 109 in a case where the motor 101 has ten poles. The rotation-phase detecting magnet 107 is a cylindrical magnet with ten poles corresponding to the number of motor poles. Each pole is evenly spaced at a mechanical angle of 36°. The Hall sensors 108 and 109 are disposed on an extension of the rotation-phase detecting magnet 107 at a mechanical angle of 18°. This configuration can detect two types of sine waves with a phase difference of 90° from each Hall sensor according to the rotation of the motor 101.

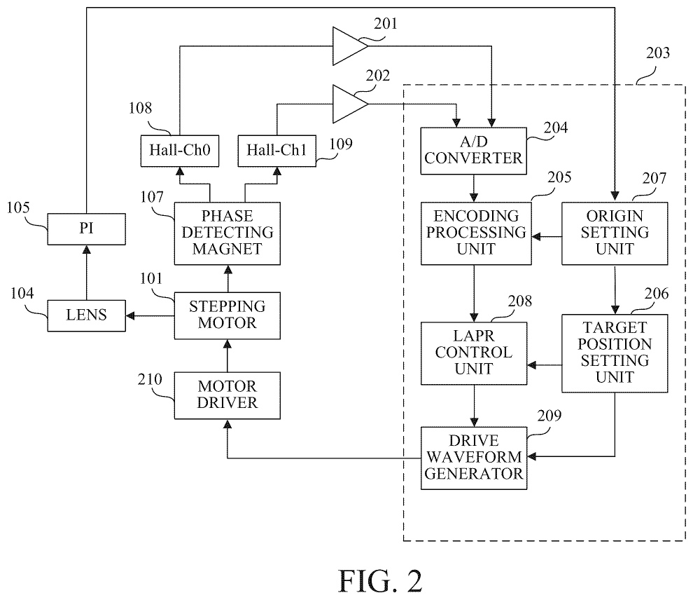

FIG. 2 is a block diagram of a motor unit including an electric circuit for driving the motor 101 according to this embodiment. In addition to the configuration of FIGS. 1A and 1, the motor unit includes amplifier circuits 201 and 202, a microcomputer (control apparatus) 203, and a motor driver 210.

The two-phase Hall signals detected by the Hall sensors 108 and 109 are amplified by the amplifier circuits 201 and 202. The amplified two-phase Hall signals are quantized by an AD converter 204, and an encoding processing unit (acquiring unit) 205 encodes the Hall signals to acquire a position detecting counter (rotational position information) that indicates an actual rotational position of the motor 101. A target position setting unit 206 generates a target position counter (target position information) for controlling the lens 104 using a target speed and target position. The same origin (origin information) for coordinates is set to the position detecting counter and the target position counter by an origin setting unit 207, and their coordinates correspond to each other. A lead angle and power rate (LAPR) control unit 208 sets a target lead angle, generates a drive counter by adding the target lead angle to the position detecting counter, and sets the power rate. Thereby, feedback control of the lead angle and amplitude of the drive waveform is performed so that the lens 104 moves following the target position counter. The power rate adjusts the amplitude of the drive waveform; for example, a power rate of 60% adjusts the amplitude of the drive waveform to 60%. A drive waveform generator 209 performs sine/cosine conversion for the drive counter and generates a two-phase drive waveform (drive signal) whose amplitude is adjusted according to the power rate. In this embodiment, the LAPR control unit 208 and the drive waveform generator 209 constitute a drive control unit.

Feedback control cannot be performed during the initialization drive until the origin is set by the origin setting unit 207, so open control is performed during this period. In this case, the LAPR control unit 208 sets the target position counter obtained from the target position setting unit 206 as the drive counter, and sets a power rate for the open control to control the drive waveform.

The generated drive waveform is converted into a motor drive signal by the motor driver 210 and supplied to the motor 101. The drive waveform is generally converted into a pulse width modulation (PWM) signal and supplied to the motor driver 210, but it may also be supplied after it undergoes A/D conversion processing, or as drive waveform information from a communication port.

### Encoding Processing to Hall Waveform

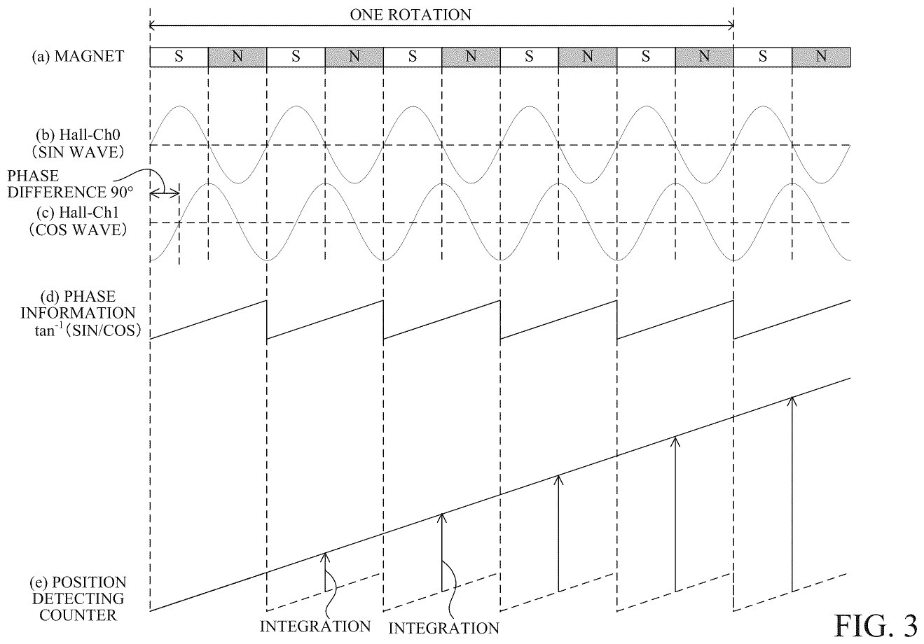

FIG. 3 illustrates the processing of the encoding processing unit 205. Here, the motor 101 has ten poles in accordance with the configuration of FIG. 1B, and the rotation-phase detecting magnet 107 also has ten poles.
(a) illustrates the rotation-phase detecting magnet 107 of the motor 101. (b) and (c) illustrate the waveforms of the Hall signals obtained at each rotation phase. Two types of Hall signals with a phase difference of 90° are obtained. Since the Hall signals are two-phase sine waves with a phase difference of 90°, the two types of signals have a sine and cosine relationship. The encoding processing unit 205 performs an arctangent operation (tan-(sin/cos)) from the Sin and Cos signals quantized by the A/D converter 204 to calculate phase information from 0° to 360°. (d) illustrates the calculated phase information. The calculated phase information is integrated to calculate rotation amount information on the motor 101. Multiplying the rotation amount information by a thread pitch of the lead screw can convert it into position information on the lens 104. Therefore, the rotation amount information on the motor 101 calculated by the encoding processing unit 205 is treated as the position detecting counter of the lens 104 as illustrated in (e). Although the phase information is information from 0° to 360° in this embodiment, it is determined by the resolution of the position detecting counter, and this embodiment is not limited to this example.

A description will now be given of the processing of the origin setting unit 207. The microcomputer 203 executes a setting sequence for the origin for the lens 104 when the power is turned on. More specifically, the lens 104 is moved to search for the lens position where the detection signal of the PI 105 switches from a high level to a low level. In a case where a reference signal indicating the switching position is acquired, the origin setting unit 207 sets the searched switching position as the origin and initializes the position detecting counter and the target position counter to predetermined values. Thereby, both origins, i.e., coordinates correspond (match), and the lens position can be controlled. The term “match” includes not only a strict match, but also a substantial match (approximate match).

### Calculation Process to Lead Angle and Power Rate

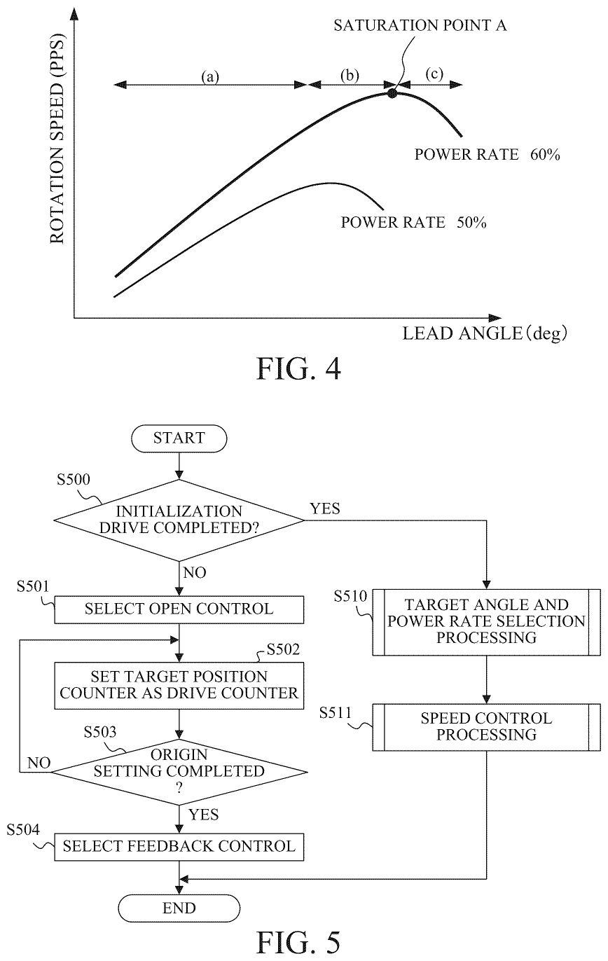

FIG. 4 illustrates a relationship between the lead angle and the rotation speed of the motor 101, in a case where the power rate is set to 50% and 60% as examples. In area (a), the rotation speed of the motor 101 increases in proportion to the increase in the lead angle. As the lead angle is further increased, it reaches area (b) where the increase in the rotation speed of the motor 101 relative to the lead angle gradually saturates. As the lead angle is further increased, it enters area (c) where the rotation speed of the motor 101 drops from saturation point A. In addition, as the power rate increases, the slope of the rotation speed of the motor 101 relative to the lead angle increases in the area (a), and saturation point A shifts to the side where the lead angle is larger. The relationship between the lead angle and the rotation speed is proportional in a range of the area (a). In other words, the relationship between the lead angle and the rotation speed is expressed by the following equation (1).

$$rotation speed = lead angle \times γ + β \qquad ( 1 )$$

where γ is a slope, and β is an offset.

In this embodiment, the relationship between the lead angle and the rotation speed is previously measured, and the slope γ, offset β, and effective area W of equation (1) corresponding to the area (a) are stored as a lead angle and rotation speed (LARS) table based on the measurement data. A plurality of LARS tables are stored for each power rate, and a proper table can be selected according to the target speed. In this case, the smaller power rate is selected with priority.

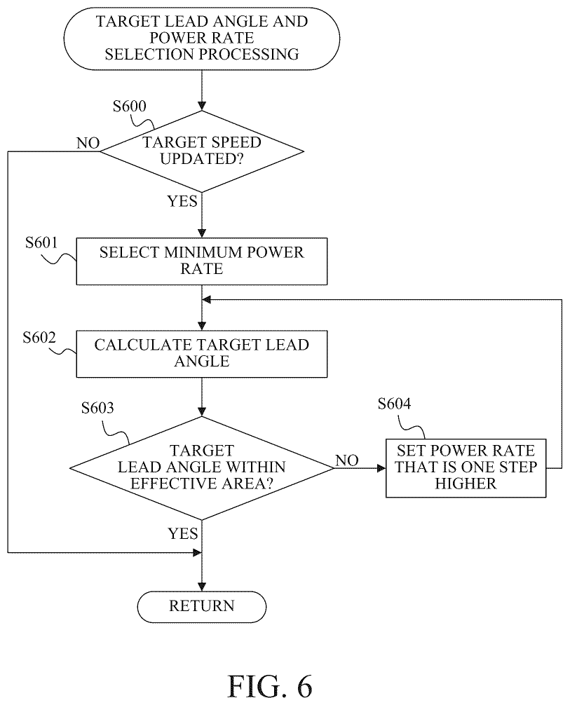

FIG. 5 is a flowchart illustrating the processing of the LAPR control unit 208. As described above with reference to FIG. 2, the same origin is set by the origin setting unit 207 for the position detecting counter and the target position counter, and the coordinates correspond to each other. Feedback control cannot be performed until the origin setting unit 207 sets the origin, and open control is performed during this period. Therefore, the LAPR control unit 208 switches its control method to open control during initialization drive and to feedback control after the initialization drive is completed.

In step S500, the LAPR control unit 208 determines whether initialization drive is completed. In a case where the LAPR control unit 208 determines that the initialization drive has been completed, it executes the processing of step S510, and in a case where it determines that the initialization drive has not been completed, it executes the processing of step S501.

In step S501, the LAPR control unit 208 selects open control.

In step S502, the LAPR control unit 208 sets the target position counter as the drive counter.

In step S503, the LAPR control unit 208 determines whether or not the completion of the origin setting in the origin setting unit 207 has been notified. In a case where the LAPR control unit 208 determines that the completion of the origin setting has been notified, it executes the processing of step S504. In a case where the LAPR control unit 208 determines that the completion of the origin setting has not been notified, it executes the processing of step S502.

In step S504, the LAPR control unit 208 selects feedback control.

In step S510, the LAPR control unit 208 executes target lead angle and power rate selection processing.

In step S511, the LAPR control unit 208 executes speed control processing.

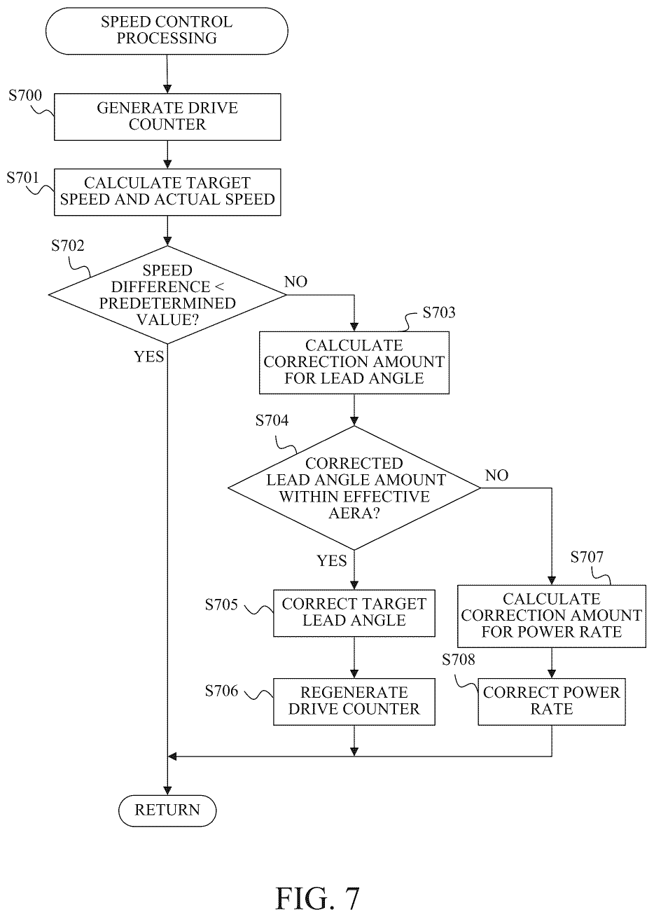

FIG. 6 is a flowchart illustrating target lead angle and power rate selection processing.

In step S600, the LAPR control unit 208 determines whether the target speed has been updated. In a case where the LAPR control unit 208 determines that the target speed has been updated, it executes the processing of step S601, and in a case where it determines that the target speed has not been updated, it terminates this flow.

In step S601, the LAPR control unit 208 selects a minimum power rate.

In step S602, the LAPR control unit 208 refers to the LARS table and target speed corresponding to the selected power rate, and calculates the target lead angle using equation (1).

In step S603, the LAPR control unit 208 determines whether the calculated target lead angle is within the effective area W. In a case where the LAPR control unit 208 determines that the position is within the effective area W, it ends this flow, and in a case where it determines that the position is outside the effective area W, it executes the process of step S604.

In step S604, the LAPR control unit 208 selects a power rate that is one step higher.

The target speed is calculated by using the shift amount (l) between the current position and the target position and the target time (t) required to move to the target position and the following equation (2).

$$target speed = shift amount ( l ) / target time ( t ) \qquad ( 2 )$$

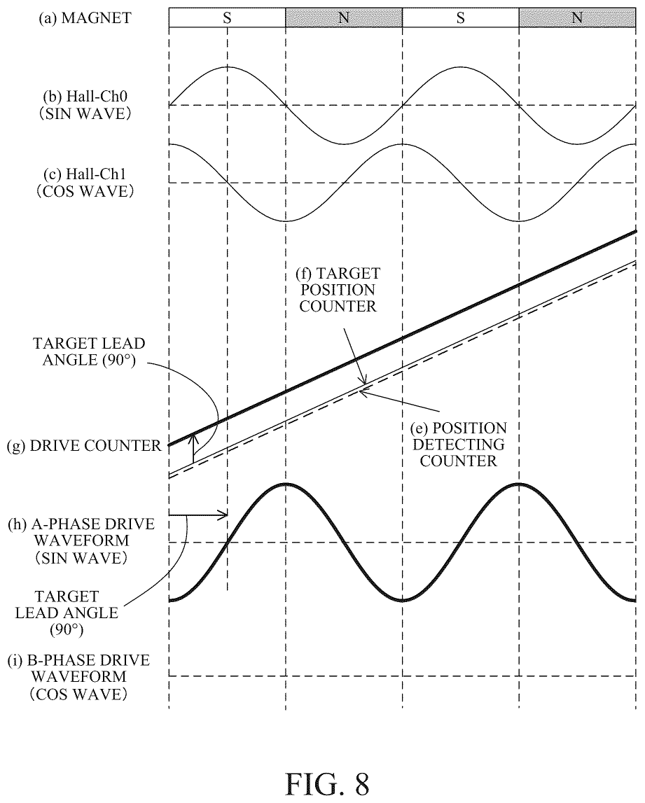

FIG. 7 is a flowchart illustrating the speed control processing. In this flow, feedback control of the lead angle and power rate of the drive waveform is processed using the target lead angle and power rate selected in the target lead angle and power rate selection processing.

In step S700, the LAPR control unit 208 generates a drive counter by adding the target lead angle to the position detecting counter.

In step S701, the LAPR control unit 208 calculates the target speed and actual speed from the slope of the target position counter and the slope of the position detecting counter.

In step S702, the LAPR control unit 208 determines whether a speed difference between the target speed and the actual speed is smaller than a predetermined amount. In a case where the LAPR control unit 208 determines that the speed difference between the target speed and the actual speed is smaller than the predetermined amount, it ends this flow, and in a case where the LAPR control unit 208 determines that the speed difference is larger than the predetermined amount, it executes the processing of step S703. In a case where the speed difference between the target speed and the actual speed is equal to the predetermined amount, which step to proceed to can be arbitrarily set.

In step S703, the LAPR control unit 208 calculates a correction amount for the lead angle. The correction amount for the lead angle is calculated using equation (3) from the relationship between the lead angle and the speed in equation (1).

$$correction amount for lead angle = speed difference amount / slope γ \qquad ( 3 )$$

where the correction amount for the lead angle needs to be limited to a range of the area (a).

In step S704, the LAPR control unit 208 determines whether the corrected lead angle amount is within a range of the effective area W. In a case where the LAPR control unit 208 determines that the corrected lead angle amount is within the range of the effective area W, it executes the processing of step S705, and in a case where it determines that the corrected lead angle amount is outside the range of the effective area W, it executes the processing of step S707.

In step S705, the LAPR control unit 208 corrects the target lead angle.

In step S706, the LAPR control unit 208 regenerates the drive counter in accordance with the correction of the target lead angle.

In step S707, the LAPR control unit 208 calculates a correction amount for the power rate. The correction amount for the power rate is calculated by multiplying the speed difference amount by a predetermined proportional, integral, or derivative gain.

In step S708, the LAPR control unit 208 corrects the power rate by the calculated correction amount for the power rate. The correction amount for the power rate is calculated by multiplying the speed difference amount by the predetermined proportional, integral, or differential gain.

Due to the above processing, speed feedback can be realized to follow the target position counter by controlling the target lead angle and power rate.

### Generation of Drive Waveform

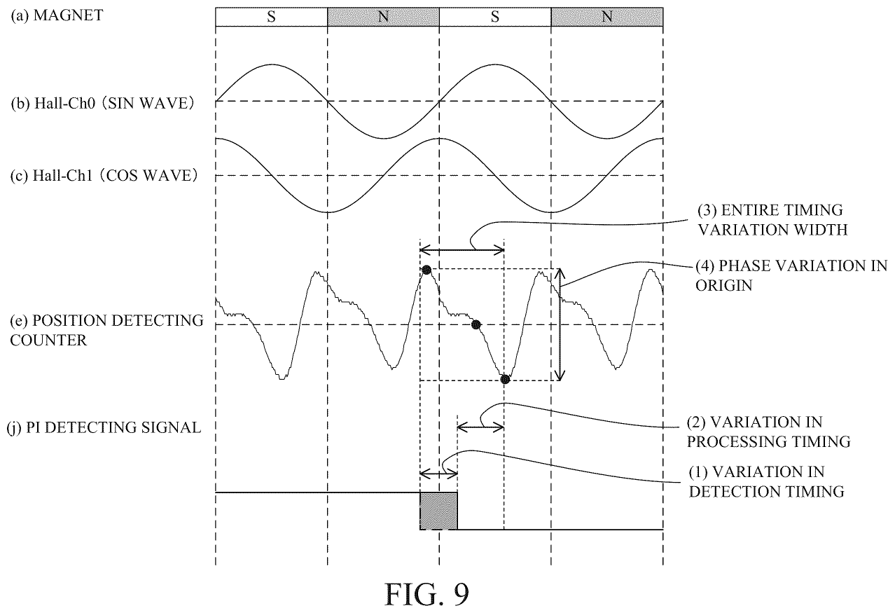

FIG. 8 illustrates lead angle control processing. (a) to (c) and (e) illustrate the same as signals described with the same reference numerals in FIG. 3, and a description thereof will be omitted. (f) illustrates a target position counter. As described above, the target lead angle and power rate are calculated so that the position detecting counter (e) follows the target position counter (f). In the following description, the target lead angle is 90° as an example.

The LAPR control unit 208 generates the drive counter (g) as angle information by superimposing the target lead angle on the position detecting counter (e). The position detecting counter is a counter obtained by integrating phase information from 0° to 360°, and the drive counter also has phase information from 0° to 360° at the lower end of the counter.

Therefore, the drive waveform generator 209 performs sine and cosine conversion for the drive counter to generate a two-phase drive waveform (sine wave (h) and cosine wave (i)) in which phase is shifted from the rotation phase of the motor 101 by a lead angle. The drive waveform is also output to the motor driver 210 after the power rate is set so as to achieve the target amplitude. Although the phase information has been described as information from 0° to 360° in this embodiment, it is determined by the resolution of the position detecting counter (e), and this embodiment is not limited to this example.

### Influence of Cogging

A phenomenon (cogging) occurs in which the magnetic attraction force pulsates due to a bias in the magnetic flux distribution of the permanent magnet as a rotor of the motor 101.

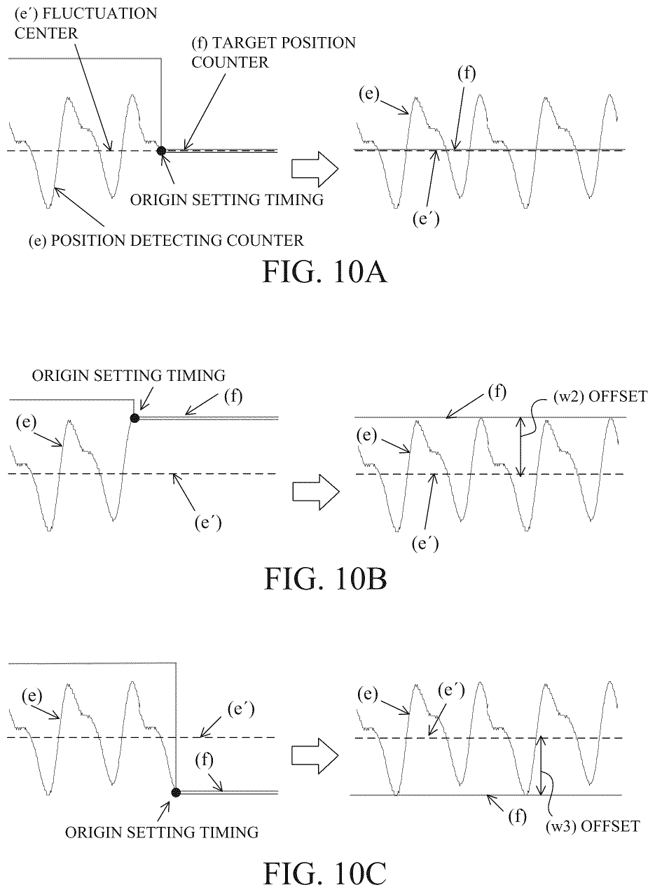

FIG. 9 illustrates a relationship between the variation in the origin setting timing and the phase variation of the origin. (a) to (c) and (e) are the same as the signals described with the same reference numerals in FIG. 3, and a description thereof will be omitted. (i) illustrates a detection signal of the PI 105. The point at which the detection signal switches from a high level to a low level is the reference position for the lens 104. In FIG. 9, the position detecting counter (e) periodically fluctuates due to rotation unevenness caused by cogging. The fluctuation of the position detecting counter (e) due to cogging occurs in synchronization with the rotation phase of the motor 101. That is, it occurs in synchronization with the detection waveforms of the Hall sensors 108 and 109 indicating the rotation phase of the motor 101. As described above, the PI 105 detects the reference position, the same origin is set to the position detecting counter and the target position counter at the timing when the reference position is detected, and the coordinates correspond to each other. However, the rotation phase of the motor 101 in a case where the PI 105 detects the reference position and the origin is set varies due to the following factors (1) to (4) illustrated in FIG. 9.
(1) Variation in detection timing caused by the PI 105 and the motor 101 that are located apart
(2) Delay of the maximum processing cycle from when the reference position is detected to when the origin setting unit 207 sets the origin (variation in processing timing)
(3) Entire timing variation width as a combination of factors (1) and (2)
(4) Fluctuation width of the position detecting counter (e) while the reference position is detected and the origin is set

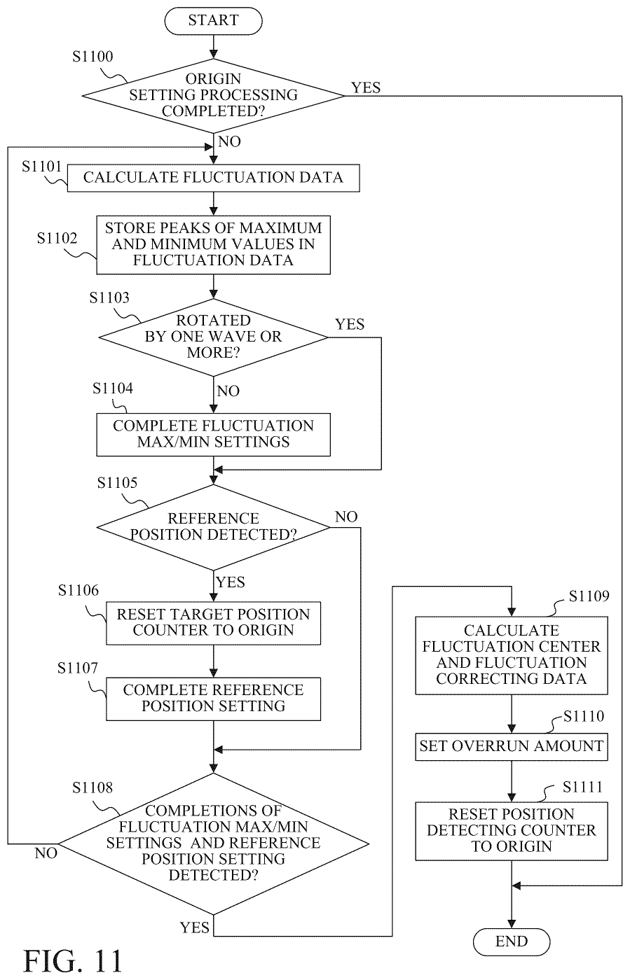

FIGS. 10A to 10C illustrate a relationship between the position detecting counter (e) and the target position counter (f) when the origin is set and when the motor is driven after the origin is set.

FIG. 10A illustrates that the origin is set at timing t1 when the position detecting counter (e) is at the center of the fluctuation (e′). In a case where the origin is set at the timing illustrated in FIG. 10A, both the target position counter (f) and the position detecting counter (e) after the origin is set move while they are equal to the fluctuation center (center value of the fluctuation amount) (e′).

FIG. 10B illustrates that the origin is set at a timing when the position detecting counter (e) shifts from the fluctuation center (e′). In a case where the origin is set at the timing illustrated in FIG. 10B, the position detecting counter (e) after the origin is set shifts from the fluctuation center (e′) by offset w2. In this case, the position detecting counter (e) is set to a coordinate shifted by the offset w2.

FIG. 10C illustrates that the origin is set at a timing when the position detecting counter (e) shifts from the fluctuation center (e′). When the origin is set at the timing illustrated in FIG. 10C, the position detecting counter (e) after the origin is set shifts from the fluctuation center (e′) by offset w3. In this case, the position detecting counter (e) is set to a coordinate shifted by the offset w3.

As described above, the coordinates of the position detecting counter (e) may shift depending on the timing of setting the origin. In other words, the coordinates may shift from the rotational position and target position of the motor 101.

The target speed in lead angle control is calculated using equation (2), the current position indicated by the position detecting counter (e), and the target position indicated by the target position counter (f). The target lead angle is set using equation (1), and the lead angle control is performed based on the set target lead angle. Therefore, in a case where there is a shift in the origin setting, the target lead angle cannot be correctly set. Furthermore, since the drive counter is generated by superimposing the target lead angle on the position detecting counter (e), in a case where there is a shift between the position detecting counter (e) and the rotational position of the motor 101, the motor 101 cannot be driven with the correct lead angle amount. The lead angle control cannot be correctly processed due to the above factors.

A description will now be given of a method for correcting an origin shift of the position detecting counter, which causes the above factors. This embodiment has described the fluctuation of the position detecting counter due to cogging as an example, but the fluctuation of the position detecting counter is not limited to this example. For example, the position detecting counter fluctuates due to mechanical factors such as uneven magnetization of the rotation-phase detecting magnet 107, axial vibration of the rotating shaft 102 mounted with the rotation-phase detecting magnet 107, and attachment position shifts of the Hall sensors 108 and 109.

### Origin Correcting Method

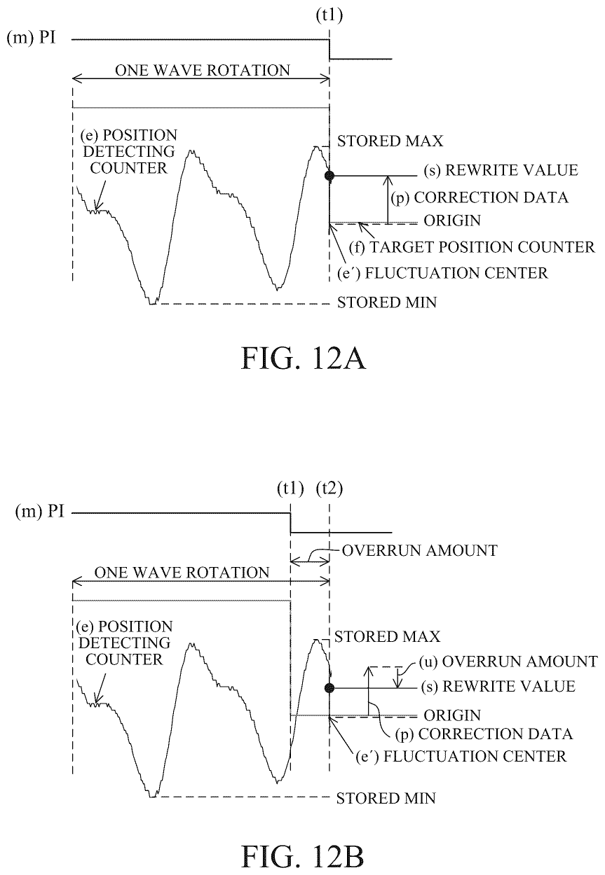

FIG. 11 is a flowchart illustrating the origin setting processing by the origin setting unit 207. In step S1100, the origin setting unit 207 determines whether the origin setting processing has been completed. In a case where the origin setting unit 207 determines that the origin setting processing has been completed, it ends this flow, and in a case where the origin setting unit 207 determines that the origin setting processing has not been completed, it executes the processing of step S1101. In step S1101, the origin setting unit 207 calculates fluctuation data from a difference between the position detecting counter (e) and the target position counter (f). In step S1102, the origin setting unit 207 stores (or holds) the peaks of the maximum value (fluctuation Max) and the minimum value (fluctuation Min) of the fluctuation data. In this embodiment, the fluctuation data refers to periodic fluctuation of the position detecting counter (e). By measuring the shift amount between the position detecting counter (e) and the target position counter (f), a slope component of the position detecting counter is removed, and only a fluctuation component can be extracted.

In step S1103, the origin setting unit 207 determines whether or not a rotation of one wave or more has been detected. One wave of the phase detecting counter (e) is one wave of the detected waveform of the Hall sensor as illustrated in FIG. 9, and is a repetitive period of the fluctuation of the phase detecting counter (e) due to cogging. In a case where the origin setting unit 207 determines that a rotation of one wave or more has been detected, it executes the processing of step S1105, and in a case where it determines that a rotation of one wave or more has not been detected, it executes the processing of step S1104.

In step S1104, the origin setting unit 207 completes setting the maximum and minimum values of the fluctuation data (fluctuation Max/Min settings).

In step S1105, the origin setting unit 207 detects a reference position that will be the origin. As described above, the reference position is a point where the detection signal of PI 105 switches from a high level to a low level.

In step S1106, the origin setting unit 207 resets the target position counter to a previously set origin.

In step S1107, the origin setting unit 207 backs up as reference position data the position detecting counter in a case where the reference position is detected, and completes the reference position setting.

In step S1108, the origin setting unit 207 determines whether it has detected the completions of fluctuation Max/Min settings and reference position setting. In a case where the origin setting unit 207 determines that it has detected the completions of the fluctuation Max/Min settings and the reference position setting, it executes the processing of step S1109, and in a case where it determines that the completions of the fluctuation Max/Min settings and the reference position setting have not been detected, it executes the processing of step S1101.

In step S1109, the origin setting unit 207 first calculates the fluctuation center of the phase detecting counter (e), and then calculates fluctuation correcting data from a difference between the detected fluctuation data and the fluctuation center. The fluctuation center is calculated by the following equation (4) as an intermediate value of the fluctuation Max and fluctuation Min in one period of the periodic fluctuation of the position detecting counter (e).

$$fluctuation center = ( fluctuation MAX and fluctuation MIN ) / 2 \qquad ( 4 )$$

In step S1110, the origin setting unit 207 sets a difference between the position detecting counter (e) and the reference position data as an overrun amount. This configuration can correct a moving amount of the position detecting counter (e) from when the reference position in step S1105 is detected to when the origin for the position detecting counter (e) is set.

In step S1111, the origin setting unit 207 resets the position detecting counter (e) at the origin corrected using the overrun amount set in step S1110 and the fluctuation correcting data calculated in step S1109 using the following equation (5).

$$corrected origin = origin - overrun amount + correction data \qquad ( 5 )$$

Correcting the origin can set the origin for the target position counter (f) such that the fluctuation center (e′) becomes the previously set origin.

This embodiment has described the fluctuation of the position detecting counter due to cogging. However, as described above, the fluctuation of the position detecting counter can also occur due to mechanical factors of the components that detect the rotation phase of the motor 101. In this case, the fluctuation period of the position detecting counter is in synchronization with the rotation period of the motor 101. At this time, the fluctuation center (e′) becomes a fluctuation center for one rotation of the motor 101. Therefore, detecting the one rotation period of the motor 101 and measuring the fluctuation Max and fluctuation Min in step S1103 can avoid an origin shift of the position detecting counter (e) caused by the mechanical factors.

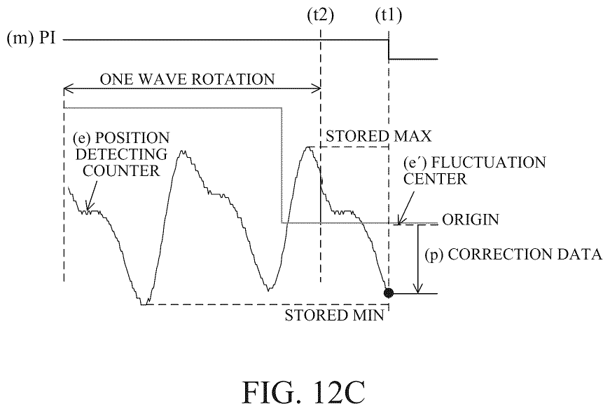

FIGS. 12A to 12C illustrate a relationship between the timings and count values when the origins for the target position counter (f) and the position detecting counter (e) are set.

FIG. 12A illustrates an origin setting flow for the target position counter (f) and the position detecting counter (e) when the timing of detecting one wave rotation or more in step S1103 coincides with the timing of detecting the reference position in step S1105. In this case, the reference position is determined at timing t1 when the PI (m) for detecting the reference position switches from a high level to a low level, and the target position counter (f) is reset to the origin at the reference position. In addition, at the same timing, the fluctuation center (e′) is calculated, and the fluctuation correcting data (p) is calculated from a difference between the fluctuation data and the fluctuation center (e′) (step S1107). At this time, the position detecting counter (e) coincides with the reference position data, so the overrun amount is 0 (step S1110). Therefore, the position detecting counter is reset to rewritten value (s) by using the origin corrected by the fluctuation correcting data (p) (S1111). As a result, the position detecting counter (e) is reset so that the fluctuation center (e′) is at a previously set origin.

FIG. 12B illustrates an origin setting flow for the position detecting counter (e) in a case where the timing t1 for detecting the reference position in step S1105 precedes timing t2 for detecting one wave rotation or more in step S1103. In this case, the reference position data is determined at the timing t1 at which PI (m) switches from a high level to a low level. The target position counter (f) is reset to the origin using the determined reference position data (step S1106). The origin for the position detecting counter (e) is set (step S1111) at the timing t2, which is later than the timing t1, so the position detecting counter (e) at this time shifts from the reference position data, and overrun amount (u) occurs (step S1110). In this case, the position detecting counter is reset by rewrite value (s) as the origin corrected with the calculated fluctuation correcting data (p) and further corrected with the overrun amount (u) (step S1111). Thereby, the origin for the position detecting counter (e) is set so that the fluctuation center (e′) is the previously set origin.

FIG. 12C illustrates an origin setting flow for the position detecting counter (e) when the timing t2 for detecting one wave rotation or more in step S1101 precedes the timing t1 for detecting the reference position in step S1105. In this case, the origins for the target position counter (f) and the position detecting counter (e) are set (step S1111) at the timing t1 at which the reference position data is set, so that the overrun amount (u) at this time is 0 (step S1110). Therefore, at the timing t1, the position detecting counter is reset by the rewrite value (s) as the origin corrected with the fluctuation correcting data (p) (S1111). Thereby, the origin for the position detecting counter (e) is set so that the fluctuation center (e′) is the previously set origin.

As described above, the configuration according to this embodiment corrects the fluctuation center (e′) of the position detecting counter (e) to the origin in any of the examples. Thereby, an offset shift of the position detecting counter (e) from the target position counter (f) can be avoided.

In this embodiment, a lens is driven as a driven member. In this case, the microcomputer 203 as a control apparatus may be provided in an image pickup apparatus that includes the lens. The microcomputer 203 may be provided in an interchangeable lens in a lens interchangeable type image pickup system. An external apparatus that is neither an interchangeable lens nor an image pickup apparatus may include the microcomputer 203, and control the lens position. The driven member is not limited to the lens. Anything that linearly drives the driven member can be driven similarly to the lens in this embodiment.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

This embodiment can provide a control apparatus that can perform excellent lead angle control.

This application claims priority to Japanese Patent Application No. 2023-135900, which was filed on Aug. 23, 2023, and which is hereby incorporated by reference herein in its entirety.

What is claimed is:

1. A control apparatus comprising:
a memory storing instructions; and
a processor configured to execute the instructions to:
generate target position information on a motor,
acquire rotational position information on the motor,
generate a drive signal of the motor according to a shift amount between the target position information and the rotational position information, and
set an origin for coordinates of the rotational position information according to a difference between a center value of a fluctuation amount of the rotational position information and a fluctuation amount of the rotational position information.

2. The control apparatus according to claim 1, wherein the processor is configured to generate the drive signal using a target lead angle generated according to the shift amount between the target position information and the rotational position information.

3. The control apparatus according to claim 2, wherein the processor is configured to generate the drive signal using a drive counter generated by superimposing the target lead angle on the rotational position information.

4. The control apparatus according to claim 3, wherein the processor is configured to generate two-phase drive signals that shift from each other by 90° from each other using angle information on the drive counter.

5. The control apparatus according to claim 1, wherein the processor is configured to:
acquire two-phase signals that are output from a pair of Hall sensors and shift from each other by 90° according to rotation of the motor, and
generate the rotational position information using the two-phase signals.

6. The control apparatus according to claim 1, wherein the processor calculates the fluctuation amount using the shift amount between the target position information and the rotational position information.

7. The control apparatus according to claim 1, wherein the rotational position information periodically fluctuates according to rotation of the motor, and
wherein the processor is configured to calculate as the center value of the fluctuation amount an intermediate value of a maximum value and a minimum value of the fluctuation amount in one cycle of periodic fluctuation.

8. The control apparatus according to claim 1, wherein the processor is configured to acquire two-phase signals that are output from a pair of Hall sensors and shift from each other by 90° according to rotation of the motor,
wherein the rotational position information periodically fluctuates according to rotation of the motor, and
wherein periodic fluctuation is in synchronization with a phase of the two-phase signals.

9. The control apparatus according to claim 1, wherein the rotational position information periodically fluctuates according to rotation of the motor, and
wherein periodic fluctuation is in synchronization with a rotation position of the motor.

10. The control apparatus according to claim 1, wherein the processor is connected to:
a movable member movable according to rotation of the motor, and
a detector configured to output a reference signal indicating a reference position set on the moving member, and
wherein the processor is configured to:
set the origin for the rotational position information based on acquisition of the reference signal,
select open control during setting of the origin for the rotational position information, and select lead angle control after the origin for the rotational position information is set.

11. The control apparatus according to claim 1, wherein the processor is configured to set the origin for the rotational position information to coincide with the origin for the target position information.

12. An image pickup apparatus comprising:
a control apparatus;
a motor;
a lens configured to move according to rotation of the motor; and
a position detector configured to detect a position of the lens,
wherein the position detector detects a reference position set for the lens,
the control apparatus includes:
a memory storing instructions; and
a processor configured to execute the instructions to:
generate target position information on the motor,
acquire rotational position information on the motor,
generate a drive signal of the motor according to a shift amount between the target position information and the rotational position information, and
set an origin for coordinates of the rotational position information according to a difference between a center value of a fluctuation amount of the rotational position information and a fluctuation amount of the rotational position information.

13. A motor control method comprises the steps of:
generating target position information on a motor;
acquiring rotational position information on the motor;
generating a drive signal of the motor according to a shift amount between the target position information and the rotational position information; and
setting an origin for coordinates of the rotational position information according to a difference between a center value of a fluctuation amount of the rotational position information and a fluctuation amount of the rotational position information.
